(19) United States
(12) Patent Application Publication
(10) Pub. No.: US 2014/0100966 A1
(43) Pub. Date: Apr. 10, 2014

(54) SYSTEMS AND METHODS FOR INTERACTIVE ADVERTISEMENTS WITH DISTRIBUTED ENGAGEMENT CHANNELS

(71) Applicants: Scott Bedard, San Carlos, CA (US); Vince Broady, Santa Monica, CA (US); Ankarino Lara, Pasadena, CA (US)

(72) Inventors: Scott Bedard, San Carlos, CA (US); Vince Broady, Santa Monica, CA (US); Ankarino Lara, Pasadena, CA (US)

(21) Appl. No.: 13/717,690

(22) Filed: Dec. 17, 2012

Related U.S. Application Data
(63) Continuation-in-part of application No. 13/644,389, filed on Oct. 4, 2012.

(51) Int. Cl. G06Q 30/02

(52) U.S. Cl. CPC G06Q 30/0277
USPC 705/14.66; 705/14.73

(57) ABSTRACT

The present invention relates to systems and methods for generating interactive advertisements which include an interactive bridge control. The interactive bridge control may include live statistics that are collected from other distribution channels. The content is optimized for each distribution channel and each advertisement network that the advertiser wishes to interact with. Distribution channels may include any of social networks, blogs, media sources, news outlets, and retailers, for example. The optimized content is published on each distribution channel and each advertisement network. When published on an advertisement network the ad includes the interactive bridge control. The system then monitors for user interaction with the interactive bridge control. When user interaction is detected with the interactive bridge control a distributed engagement channel may be displayed. These user interactions may also be tracked.

### CROSS REFERENCE TO RELATED APPLICATIONS

This application claims priority to U.S. patent application Ser. No. 13/644,389, by Bedard et al., entitled “Systems and Methods for Automated Reprogramming of Displayed Content”, filed on Oct. 4, 2012, which application is incorporated herein in its entirety by this reference.

### BACKGROUND

The present invention relates to systems and methods for interactive advertisements with distributed engagement channels for providing content to a user. Such systems and methods are particularly useful in the context of online activities, and may be especially useful in social media and advertising. Such systems and methods enable advertisers to make their ads more relevant to users, and to better maximize online advertisement real estate.

Unlike physical real estate, virtual space is nearly unlimited, but only in particular channels. For example, a product may have a social media site entirely dedicated to the product, or even a brand website entirely dedicated to the brand and/or product. This online presence is “cheap” and virtually limitless, but does not connect to most users.

In contrast, advertising networks enable the placement of banner ads on search pages, news sources and other online sites, but require a premium to do so. Further, these ads are typically limited in space. Thus there is typically a tradeoff between user traffic to a channel, and its cost.

As such, most sophisticated retailers rely upon both banner style ads, which are very limited in terms of online real estate, but intended to reach a large number of users, and dedicated social media and branded websites, which enable a far more immersive experience for users, but typically only draw a subset of users which actively seek out the product.

The reason social media sites and branded websites are valuable is that it provides an outlet for users to comment or otherwise interact with the product. Additionally, due to the social sharing aspects of sites like Facebook, the product may leverage the user's network to reach additional customers.

Unfortunately, these interactive qualities are typically missing from web advertising (e.g. banner ads) that is found on content pages (e.g. search engine results, news site, personal Facebook page, etc.). Instead, users are invited to click on the ad and be taken to the advertiser's “landing page”, which may include the branded site or social media page. However, to date, as noted, users are not invited to comment on the ad inline and/or to share it with friends.

It is therefore apparent that an urgent need exists for improved systems and methods for distributed engagement channels for product advertising. Such systems and methods would be able to provide users an interactive quality to advertisements, and further to mine these interactions to enhance advertiser efficiency. Ultimately such systems and methods may help drive enhanced retail activity and profitability.

### SUMMARY

To achieve the foregoing and in accordance with the present invention, systems and methods for interactive advertisements and distributed engagement channels are provided. Such systems and methods enable content to be tailored to a user, and have content from a wide range of distribution channels provided to the user through a single ad source. Such systems and methods make interaction with advertisements more appealing to users, and help overcome “banner blindness”.

In some embodiments, the systems and methods for interactive advertisements generate an interactive bridge control for content. In some cases the interactive bridge control includes live statistics that may be collected from other distribution channels. The content is optimized for each distribution channel and each advertisement network with which the advertiser wishes to interact. Distribution channels may include any of social networks, blogs, media sources, news outlets, and retailers, for example.

Content optimization relies upon knowing the user's identity (often through a cookie loaded onto their device) and linking the user to a set of preferences that have been compiled from other user interactions. These preferences are known as the user's “psychological profile”. The system may identify a target result, and select content which increases the probabilities of the target result occurring based upon the psychological profile.

After the content is optimized, it may be published on each distribution channel and each advertisement network. When published on an advertisement network the ad includes the interactive bridge control. The system then monitors for user interaction with the interactive bridge control. When user interaction is detected with the interactive bridge control a distributed engagement channel may be displayed. These user interactions may also be tracked.

The distributed engagement channel is either a mini distributed engagement channel or an expanded distributed engagement channel. Both types of distributed engagement channel include content collected from other distribution channels, although the expanded distributed engagement channel is more content rich than the mini distributed engagement channel. Additionally, the mini distributed engagement channel is displayed in line with the user's browsing. In some cases the expanded distributed engagement channel is a branded website.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example functional block diagram illustrating users engaging a content management system and advertisement networks, in accordance with some embodiments;

FIG. 2A is an example block diagram for the content management system, in accordance with some embodiments;

FIG. 2B is an example block diagram for the content generator, in accordance with some embodiments;

FIG. 3 is an example flow chart for the process of a product provider engaging with a content management system for interactive ad generation, in accordance with some embodiments;

FIG. 4 is an is an example flow chart for the process of building an interactive bridge button, in accordance with some embodiments;

FIG. 5 is an example flow chart for interactive ad management, in accordance with some embodiments;

FIG. 6 is an example flow chart for content management system operation, in accordance with some embodiments;

FIG. 7 is an example flow chart for content optimization, in accordance with some embodiments;

FIG. 8 is an example flow chart for feedback analysis, in accordance with some embodiments;

FIG. 9 is an example flow chart for user tracking, in accordance with some embodiments;

FIG. 10A is an example screenshot of an interactive advertisement, in accordance with some embodiments;

FIG. 10B is an example screenshot of a mini distributed engagement channel, in accordance with some embodiments;

FIG. 10C is an example screenshot of an extended distributed engagement channel, in accordance with some embodiments;

FIG. 10D is an example screenshot of a branded channel, in accordance with some embodiments; and

FIGS. 11A and 11B are example illustrations for computer systems configured to embody the automated reprogramming system, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to a novel and improved means, systems and methods for providing and managing interactive ads which enable distributed engagement channels (DECs). These systems and methods may be particularly useful within social media settings, where user data is rich, but may be extended to any suitable platform. Additionally, the following systems and methods are reliant upon content being unicast to the user, as opposed to broadcasted content.

Note that while much of the discussion contained herein relates to content providers over the internet, it is possible that alternate system and methods may be employed within any content distribution framework, such as an interactive television network, as long as the content provided to each user may be granularly selected for said user. As such, any network that allows users to access specific data may employ the following systems and methods.

Further, while much of the following discussion will center on social networks providing content to the users, it is entirely possible that any content provider may utilize the disclosed systems and methods. For example, media sources, such as YouTube, news outlets, such as CNN online, and online retailers, such as Amazon, may all be considered “content providers” or “distribution channels” for the purposes of this disclosure.

Lastly, while the term “content” is commonly utilized in this disclosure to mean advertisements, promotions or offers (monetization vehicles) it is entirely possible that content may include non-advertisement content. It may be desirable to capture the user's interest for as long as possible, since many websites are valued based upon user traffic. By tailoring content displayed upon the website to the user, and making advertisements interactive, they may spend more time on the particular site without the desire to navigate away from the content provider.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Interactive Advertisement System

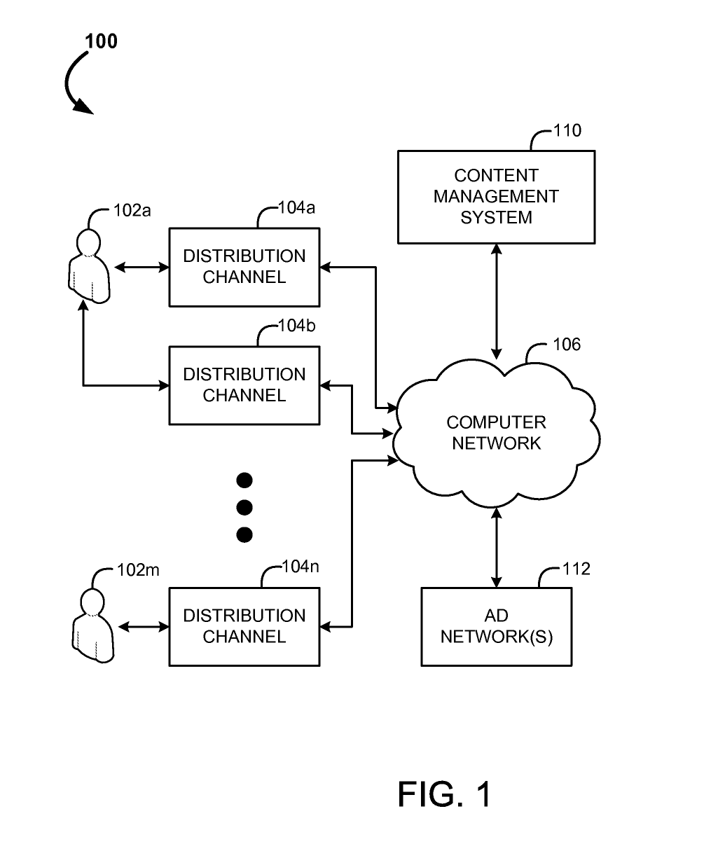

To facilitate the discussion, FIG. 1 is an example functional block diagram 100 illustrating users 102a to 102m engaging distribution channels 104a to 104n in conjunction with a content management system 110 to tailor the content displayed, and deliver interactive advertisements. In this particular example illustration, two users 102a to 102m are seen interacting with one or more distribution channels 104a to 104n. While distribution channels 104a to 104n are illustrated in this example illustration, it is considered within the scope of this disclosure that a wide variety of websites may be accessed by the users 102a to 102m, including entertainment sites, news outlets, retailers, search engines, blogs, informational and reference pages, websites for organizations, social media sites, branded websites, or any other distribution channel accessible by a user.

The distribution channels 104a to 104n are accessed by the users 102a to 102m via a computer network 106. In some embodiments, the computer network 106 is the internet; however, it is possible that the computer network 106 may include any wide area network, local area network, company network, interactive television network, etc. The computer network 106 additionally couples the distribution channels 104a to 104n to a content management system 110 and advertisement network(s) 112.

The advertisement network(s) 112 may receive content from the content management system 110 in the form of advertisements with an interactive bridge field or “button” that links the advertisement to one or more Distributed Engagement Channels (DECs). The DECs may integrate content from one or more of the distribution channels 104a to 104n in order to seamlessly develop an expanded interface for the user. DECs will be described in greater detail below.

In some embodiments, a user 102a may access a distribution channel 104a. The distribution channel 104a provides content to the user 102a. In some cases, the content provided to the user 102a may be selected by the content management system 110. In some particular embodiments, the content management system 110 operates in the background to analyze the sentiments of the user 102a to determine what content will be provided to the user. In these embodiments, the content management system 110 is capable of tying each user 102a to a persistent identification, and is linked to the user's 102a identification in each distribution channel they frequent. This persistent identification allows the sentiment of the user 102a to be tracked across various social networks 104a to 104n (or other distribution channels). This enables the content management system 110 to learn about the user 102a, develop a personality profile, and make more exact predictions regarding how the user 102a will react to any particular content.

The ad network 112 provides banner ads (or other online advertisements) to the distribution channels in reaction to the content management system 110. As stated earlier, these ads include an interactive bridge button which links the ad to one or more DECs populated with information being derived from the product's branded website, or social media sites for the product.

For example, assume a new sports shoe is being advertised. The content management system 110 is provided content for the shoe, including advertisement images, possibly multimedia content (e.g. promotional video), taglines, statistics, and feeds from one or more distribution channels which are centered on the product. The content management system may then optimize this content for display on any number of distribution channels. For example, a branded website may include all the content, whereas a YouTube channel may have a description of the product uploaded along with the promotional video. Likewise, a Facebook page, and Twitter feed could be generated for the product (in addition to other channels).

In addition, content developed on these channels may be tracked by the content management system 110 and utilized to populate the DEC or even the interactive bridge button, as will be discussed in greater detail below. This collected content may include the number of “likes” for example, as well as comments by users.

The content management system 110 also provides the content for the product to the ad networks 112 with an embedded interactive bridge button. The ad networks (such as AdChoice) may then post the advertisements on banners or other real estate on other distribution channels in accordance with their own selection criteria, or according to the direction of the content management system 110. In some embodiments, the content management system may dictate ad display in response to tracking user identity and analyzing the user's sentiment and personality.

The interactive bridge button may include a simple field that, when selected by the user, displays a mini DEC or expanded DEC, which incorporates content from the content management system and that is collected from the branded websites and/or social media sites. For example, the DEC may include recent comments on the product, live statistics (such as “likes”, followers, number of users viewing the product, number of recent sales, etc.). The DEC may also include more traditional content such as images of the product, slogans and media.

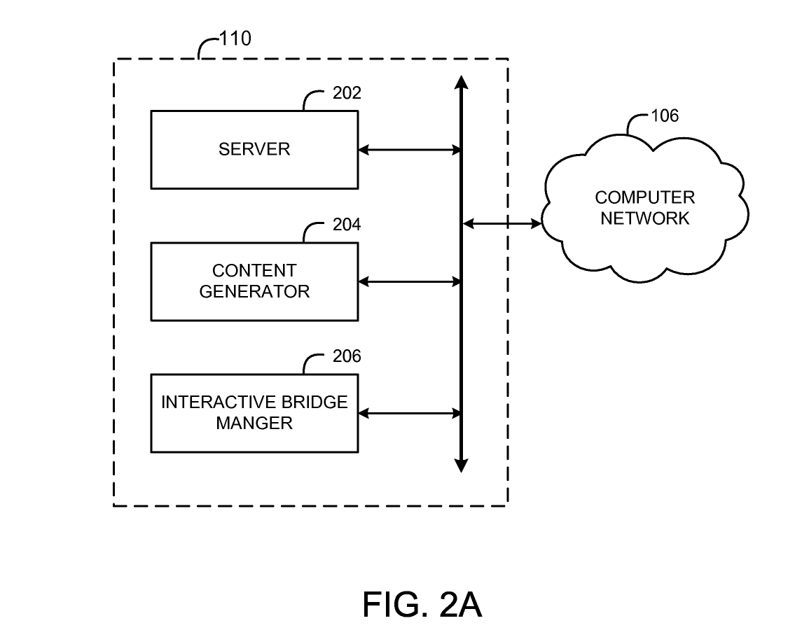

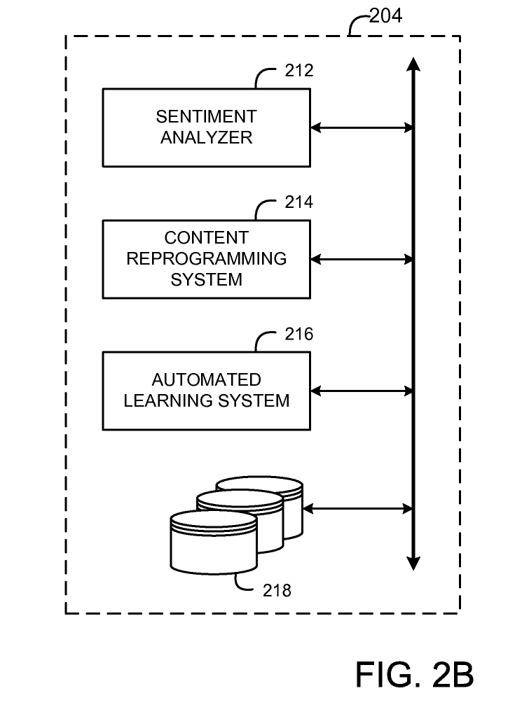

FIG. 2A is an example block diagram for the content management system 110, in accordance with some embodiments. The content management system 110 includes a server 202, a content generator 204, and an interactive bridge manager 206. Each of these subsystems is a logical component of the content management system 110 and is logically coupled to one another. In cases in which these subsystems are embodied upon a single device, or operating within a cloud environment, the coupling may be merely logical in nature. When these subsystems are embodied within separate devices, the coupling may include a physical connection, such as a central bus.

Each component of the content management system 110 may likewise access the computer network 106. The server 202 may interact directly with the social networks 104a to 104n (or other distribution channels) in order to provide the content selection for a given user 102a, as well as interact with the ad networks 112.

The interactive bridge manager 206 may generate the interactive bridge button for inclusion in the advertisements, which DECs they link with, and which content (comments, live stats, etc.) they pull from. In some embodiments, the generated interactive bridge button may even include live statistics or other personalized content for the user. Likewise, the content generator 204 may utilize content to optimize it for each distribution channel as described above.

FIG. 2B provides even greater detail of some example content generator 204, useful in association with some embodiments. In this example content generator 204 a profile for the user 102a may be employed by a sentiment analyzer 212 in order to generate probabilities that the given user 102a will react positively to a given piece of content. The profiles and available content may be stored within a database 218.

A content reprogramming system 214 may take the selected content and reprogram the distribution channel 104a to include the content. This may include formatting the content in a manner acceptable to the distribution channel 104a. An automated learning system 216 may analyze feedback provided by the user 102a in order to populate or update that individual's profile. This “learning” element of this example content generator 204 may occur across multiple social networks 104a to 104n and other distribution channels, thereby providing the content generator 204 unprecedented opportunities to develop a rich dataset regarding the user 102a.

### II. Interactive Advertisement Process

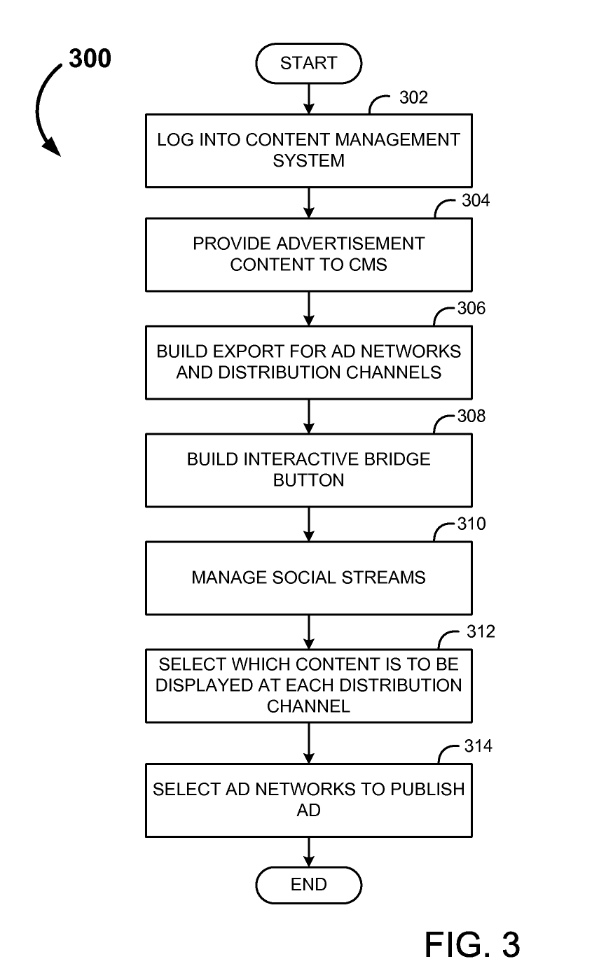

FIG. 3 is an example flow chart 300 for the process of a product provider (advertiser) engaging with a content management system for interactive ad generation, in accordance with some embodiments. In this process a content provider may log into the content management system (at 302), and provide advertisement content to said content management system (at 304). The content management system may build exports for advertisement networks and the distribution channels (at 306) using the content. This may include optimizing content for each channel's capabilities, real estate availability, viewer demographics, etc.

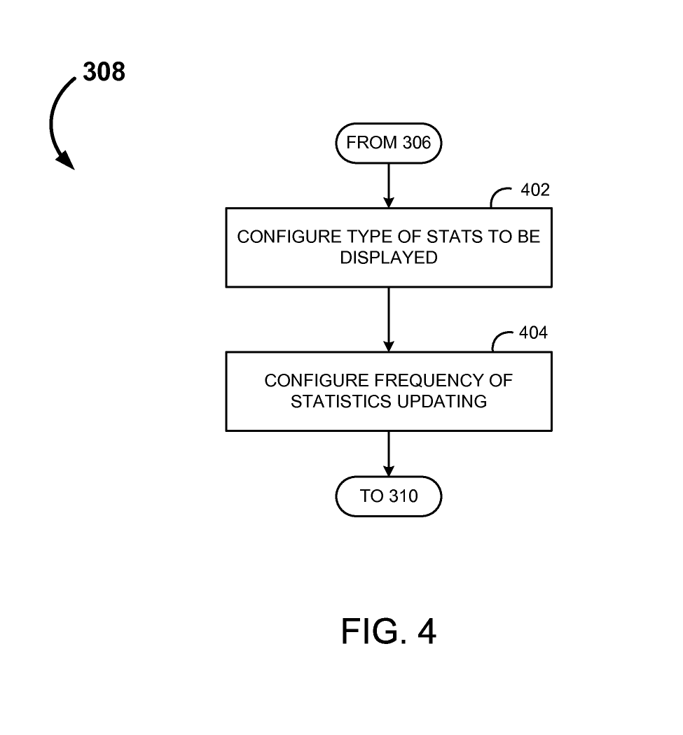

Subsequently, the interactive bridge button may be generated (at 308). FIG. 4 provides a more detailed example process for the generation of the interactive bridge button. In this example, the type of statistics to be displayed in the interactive bridge button may be configured (at 402), as well as the frequency of statistics updating (at 404). These statistics may be intended for display in the distributed engagement channel, or even on the button located in the advertisement.

Returning to FIG. 3, after the interactive bridge button has been generated, the social streams may be managed (at 310). This includes compiling comment streams from various distribution channels, and other statistics from the distribution channels. The system may also select which content is to be displayed at each distribution channel (at 312). Lastly, the ad networks for display of the ads may be selected (at 314). As previously noted, content selection and publishing selections may rely upon user sentiments and personalities in order to increase effectiveness of advertisements. Specific means of accomplishing content selection will be described in more detail below.

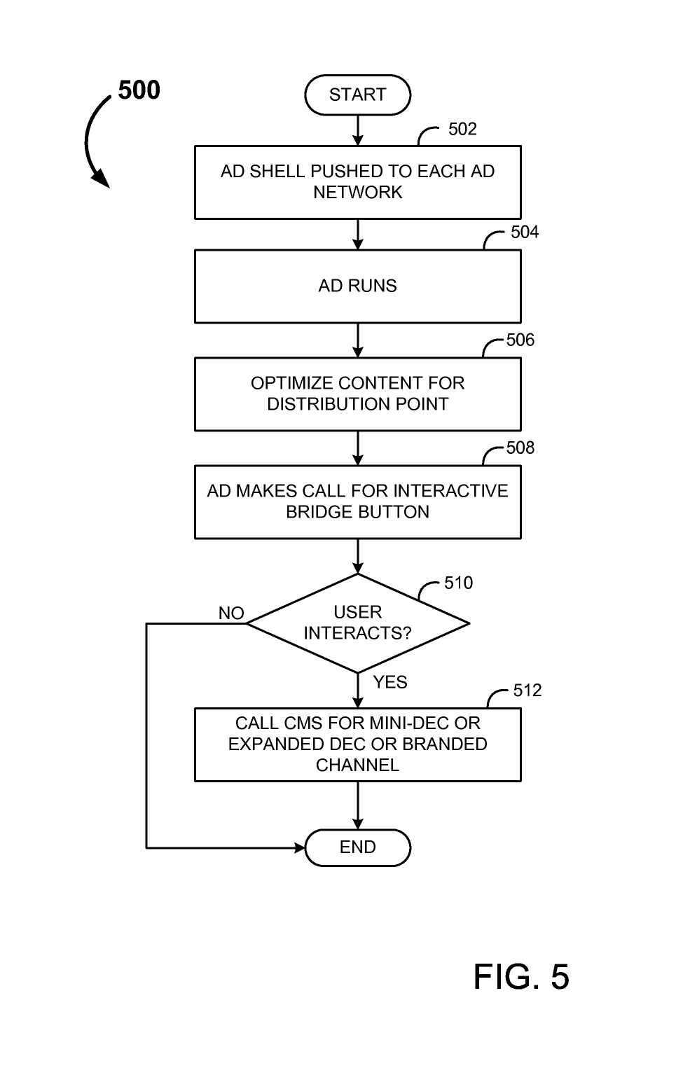

FIG. 5 is an example flow chart 500 for interactive ad management (seen from the content management system perspective), in accordance with some embodiments. This process begins with the publishing (at 502) of the ad shell to each ad network that had previously been selected. The ad shell may include flash, java or other known methods. The ad is run by the network (at 504). Additionally, the content is optimized for display at the distribution point the ad is located at (at 506) if the ad code is capable of determining its location. For example, some sites may complement a particular ad color scheme better than others, and as such the ad may be optimized for demographic or aesthetic appeal at the particular distribution point.

As the ad runs, it makes a call for the interactive bridge button (at 508) including live stats and/or other content to be displayed. By incorporating live statistics, the interactive button may overcome “banner blindness” that is common to many web users. Hopefully the user then interacts (at 510) in which case the ad code calls the content management system for a mini or expanded distributed engagement channel (at 512). As noted earlier, the mini or expanded distributed engagement channel is a function of the content provided by the advertiser and/or user generated content across any of the distribution channels.

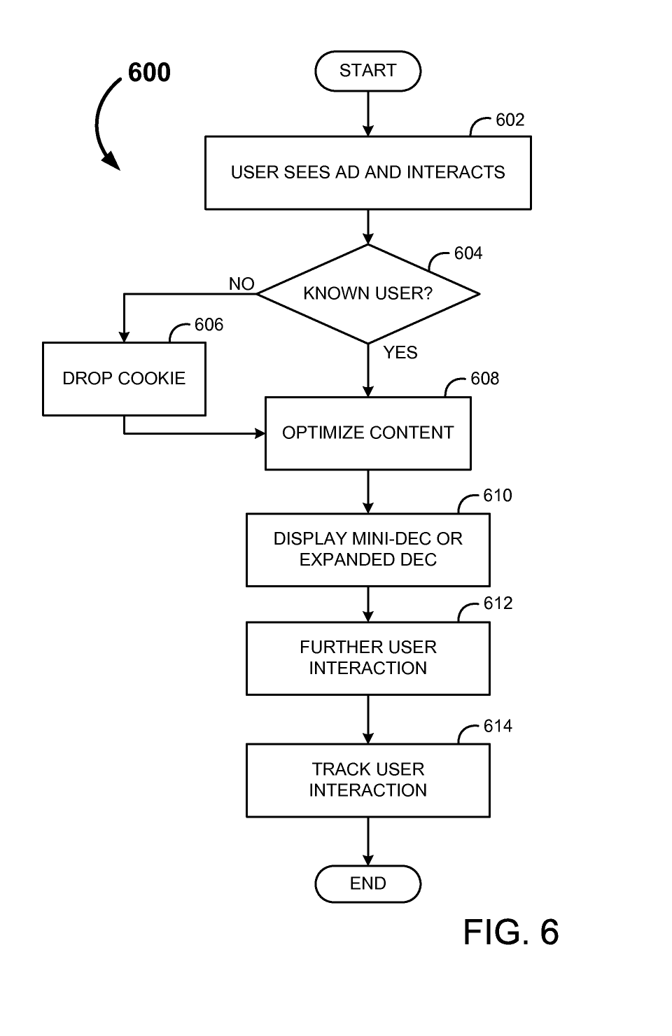

FIG. 6 is an example flow chart 600 for content management system operation as observed by a user system, in accordance with some embodiments. In this example process, the user sees the advertisement and interacts by selecting the interactive bridge button (at 602). At this stage, the system determines if the user is known (at 604) by looking for a persistent identification of the user. Users are “known” when they can be tied to a psychological profile. The content management system may identify tracking cookies upon the user's computer (or other computational device, such as tablets, mobile devices, etc.). If no identifying cookie exists, some embodiments of the content management system may alternatively identify the user by device MAC address or other indication. In some embodiments, the user is known if she is logged into the distribution channel. For example, a user must supply a password and username to access their profile in Facebook or Twitter. The distribution channel can use this authentication process in order to inform the content management system of the user's identity. By leveraging both login data and cookies, the content management system may be able to track users even when they are using different devices, and across different unrelated distribution channels. If the user is not known a cookie (or other identifier) may be dropped onto the user's system (at 606). This identifier facilitates tracking the user across various distribution channels (such as Twitter and Facebook, for example).

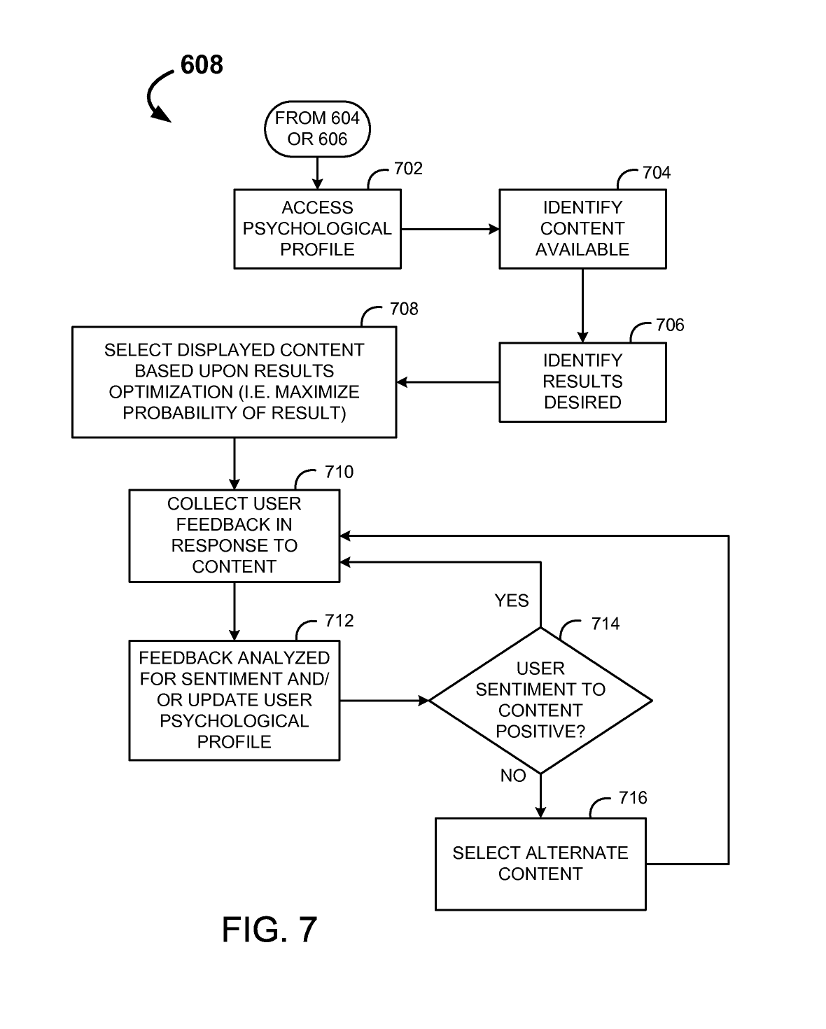

Next, the content is optimized for the user using the user's identification (at 608). Content optimization is described in greater detail in relation to FIG. 7, where the user's history is analyzed (at 702). History analysis may include accessing the user's psychological profile from storage. Alternatively, if the user is not known, an ID may be generated for the user which is associated with a new user psychological profile. The new psychological profile may be blank initially, or may include one of potentially several default profiles based upon “stereotypical” users that access the distribution channel, or otherwise based upon the user's activity.

The psychological profile may include any number of variables that can be utilized to model user response to content. Typically, a psychological profile may include sentiments, interests, demographics, states of mind, habits, and networks, for example. Sentiments may indicate an overall personality such as “negative”, or “optimistic”. Interests may include topics the user is interested in, such as “movies”, “fashion” or “food”. Demographics may include information such as age, race, gender, and socioeconomics. States of mind may include overarching themes the user is involved in, such as “getting married”, “having a baby”, “buying a house” or other such life events that are persistently impacting the user. Habits may include behavioral habits such as being a “purchaser” or “sharer”. Network may include the user's friend lists and other contacts.

Once the psychological profile has been retrieved from storage (or newly generated) the system queries the database for the content that is available for display to the user (at 704). The desired result is then determined by the system (at 706). The desired result, in the case of an advertisement, may include the user clicking upon the ad, or accessing the website that the advertisement is promoting. If the content is non-advertisement material, the desired result may include staying longer on the webpage, or exploring the content in greater detail. Other desirable results may include sharing of the content, making a purchase, broadcasting the content, or building up reputation of the content (typically through positive comments).

Once the system identifies which result is desired, it then models the probability of that result occurring for each of the available items of content based upon the user profile (at 708). This modeling may compare how other users with similar psychological profiles reacted to the content in order to build a probability function where each category in the psychological profile is a variable. The system may then optimize for the largest probability of the result occurring, given the available content. In some embodiments, vector analysis, or other optimization techniques may be employed for selection of content.

Once the content has been selected and displayed, the system collects feedback from the user (at 710) in response to the content. This feedback may include a comment, a desired result, or some other action by the user. The feedback may be analyzed for sentiment and the user's psychological profile may be updated (at 712).

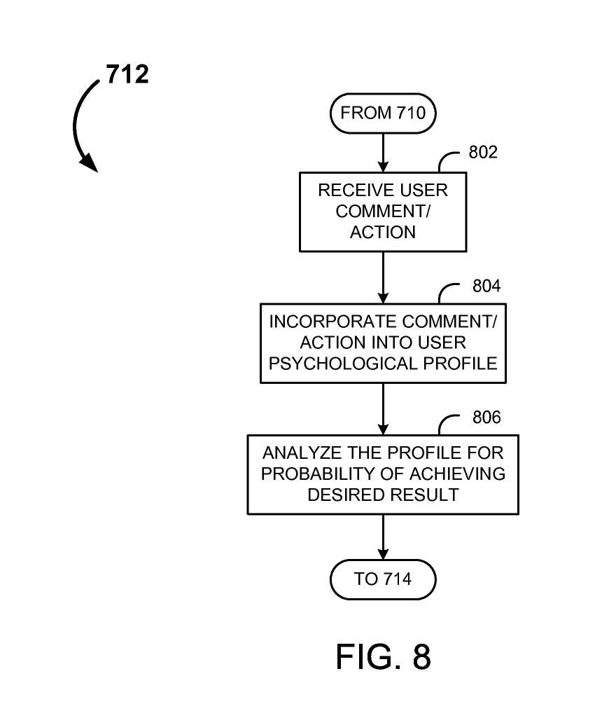

Turning now to FIG. 8, an example flow chart for the process of feedback analysis is illustrated. In this example process, the user's comment or action is received (at 802), and the comment or action is incorporated into the user's psychological profile (at 804). After the profile has been updated, it is again analyzed for the probability of achieving the desired result (at 806) in a manner similar to that discussed above.

Returning to FIG. 7, the system determines if the user's sentiment is positive (at 714), and if so maintains the content and awaits further user feedback. However, if the user reacts negatively to the content, then the system may select alternative content (at 716) using the updated psychological profile and probabilities.

In this manner, the system may build out a robust psychological profile for the user and leverage the profile to maximize the chance that content will have a desired result. If the system receives a negative feedback from the user, the profile is updated, and the content reviewed for alternatives. This ensures the user is consistently provided relevant and desirable content.

Further, by utilizing a cookie tied to the user's ID, the system is able to track the user across different distribution channels' platforms. Thus, comments on a Facebook page may bolster the user's psychological profile and alter the content the user may experience on an entirely different portal, such as YouTube.

Returning to FIG. 6, after the optimization of content, the system may display a distributed engagement channel to the user (at 610). The distributed engagement channel may be a smaller and content poor mini-DEC which provides the user a taste of the product features and live stats. Alternatively, an expanded DEC may be illustrated. In some embodiments, the expanded DEC may even be a social media distribution channel or full branded website (i.e. “landing page”).

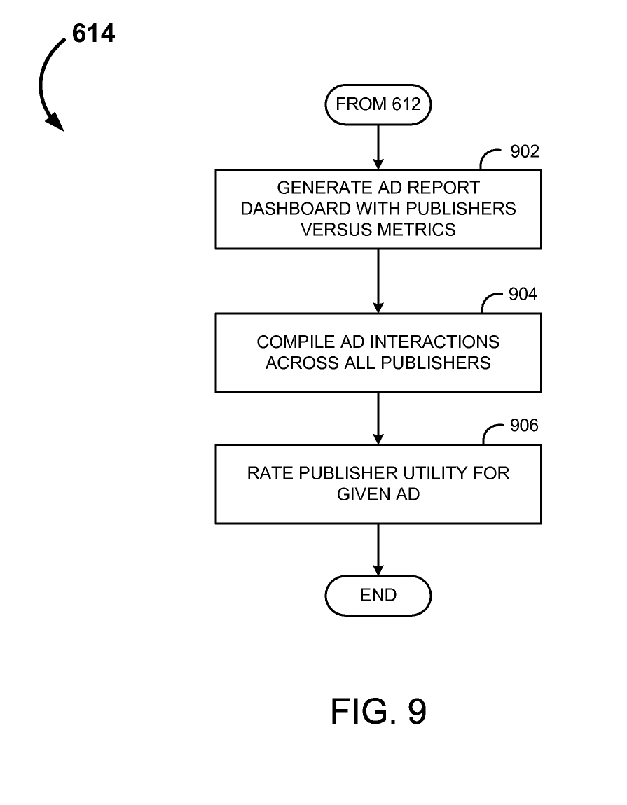

Next the system determines if the user engages in any further interaction (at 612) such as viewing a media file, commenting, etc. The system tracks such interactions (at 614) in order to generate a dashboard indicating which ads are particularly useful. A more detailed process diagram for the interaction tracking is provided at FIG. 9. Here an ad report dashboard is generated (at 902) which illustrates publishers versus performance metrics. The system compiles the ad interactions across all publishers (at 904) and rates the publisher utility for a given ad. Below is an example of a tracking dashboard:

| | | | Advertisements | | | |
|---|---|---|---|---|---|---|
| Action | Facebook | YouTube | NY Times | CNET | • • • | Yahoo! |
| Trailer | 1000 | 900 | 50 | 10 | • • • | 1000 |
| view | | | | | | |
| Social | 10 | 20 | 1 | 5 | • • • | 20 |
| Post | | | | | | |
| User | 1 | 2 | 5 | 3 | • • • | 10 |
| Generated | | | | | | |
| Content | | | | | | |
| (UGC) | | | | | | |
| entries | | | | | | |

In this example dashboard, the metrics include trailer views, social posts, and user generated content entries. The channels include Facebook, YouTube, and advertisement networks (including at least New York Times, CNET and Yahoo!). Through this Dashboard, at a glance, the advertiser can get a picture of the relative utility of each channel. For example, NY Times and CNET generate significantly less user interactions than Yahoo! In this example. In this manner the system may rate publisher utility for a given ad (at 906).

As previously indicated, tracking of user interaction relies upon the existence of a persistent identity for a given user. In some embodiments, this persistent identity may take the form of a cookie residing on the user's computer.

### III. Example Screenshots

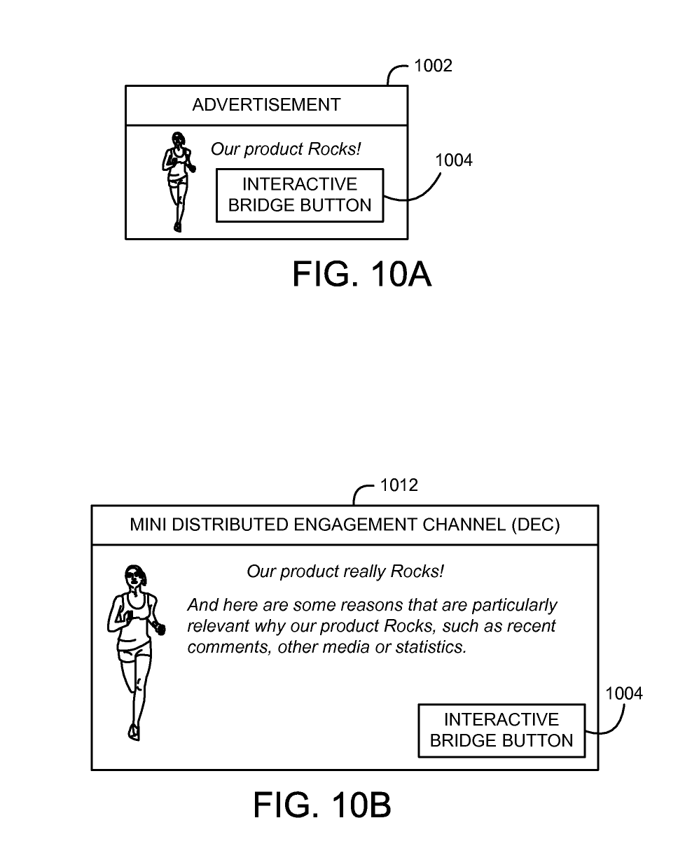

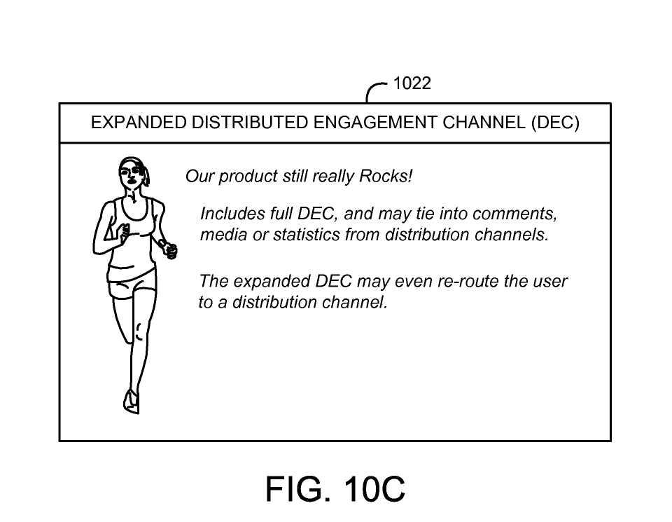

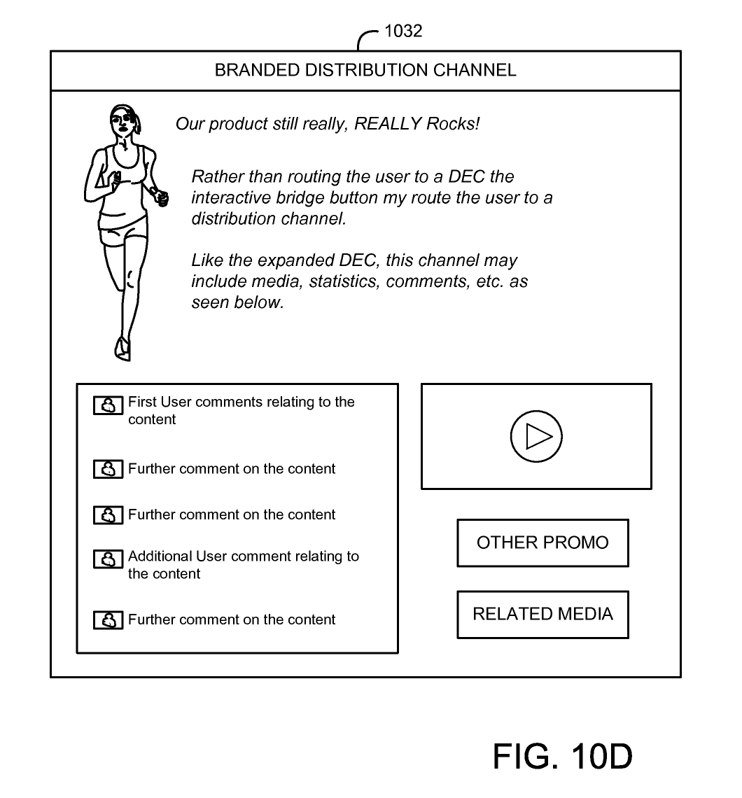

FIGS. 10A to 10D provide some example screenshots to better illustrate the disclosed systems and methods. In FIG. 10A a banner ad 1002 that has been generated from the content is illustrated. This banner ad 1002 is exemplary in nature, and is not intended to limit the scope of the present disclosure.

In this example, the banner ad may be for sporting footwear. The advertisement includes an image intended to draw in the user's attention, and possibly a slogan. Content of the ad may vary depending upon content, product being advertised, expected audience, etc. Notably, the advertisement includes an interactive bridge button 1004, which may include live statistics pulled from one or more other distribution channels.

If the user interacts with the interactive bridge button 1004 or, in some embodiments, with the banner ad 1002 generally, the system may display the mini DEC 1012, shown in FIG. 10B, in line with the user's current web browsing. In alternate embodiments, the interactive bridge button 1004 may cause an expanded DEC 1022 to be displayed, as shown in FIG. 10C. In some embodiments, the expanded DEC may even include a branded website 1032, as seen in relation to FIG. 10D.

The mini DEC 1012, as noted, may expand from the ad to enable in-line viewing of the content, without redirecting the user. This unobtrusive means for increasing user interaction is minimally disruptive to the user, thereby increasing likelihood of future interactions.

The mini DEC 1012 still includes the interactive bridge button 1004 to enable a user to interact further and be routed to an expanded DEC or branded webpage. Additionally the mini DEC includes more content that is collected from the distribution channels. This makes the mini DEC relevant to the user, incorporates real time and social elements, and is more likely to capture user attention. This content may be optimized based upon the user's profile, and may include any of media, statistics, other user comments, or the like.

Turning to FIG. 10C, the expanded DEC may include much of the same sort of content as present on the mini DEC, but since real estate is less limited, more content is provided. Lastly, the branded distribution channel 1032 may include many of the same elements as the mini and expanded DECs, but may be entirely dedicated to the product. This is the stereotypical “landing page” known in the art, except that the website may include comments and statistics collected from alternate distribution channels, and may even be optimized for the user depending upon their personality profile.

Further, the personality profile generated for the user may even be employed to determine if the user is directed to the mini DEC, expanded DEC or branded website based upon previous user interactions and their response. For example, one user may be annoyed by a redirection away from their current browsing and thereby avoid clicking on banner ads. If this information is stored in the personality profile, the system may utilize a mini DEC for this user to make interaction more appealing. In contrast, another user may not mind redirection, and in fact is more likely to make a desired result (i.e. comment, sharing, purchase, etc.) if on the branded website. For such a user, the system may forgo the mini DEC, and instead directly display the branded distribution channel to the user upon interaction.

### IV. System Embodiments

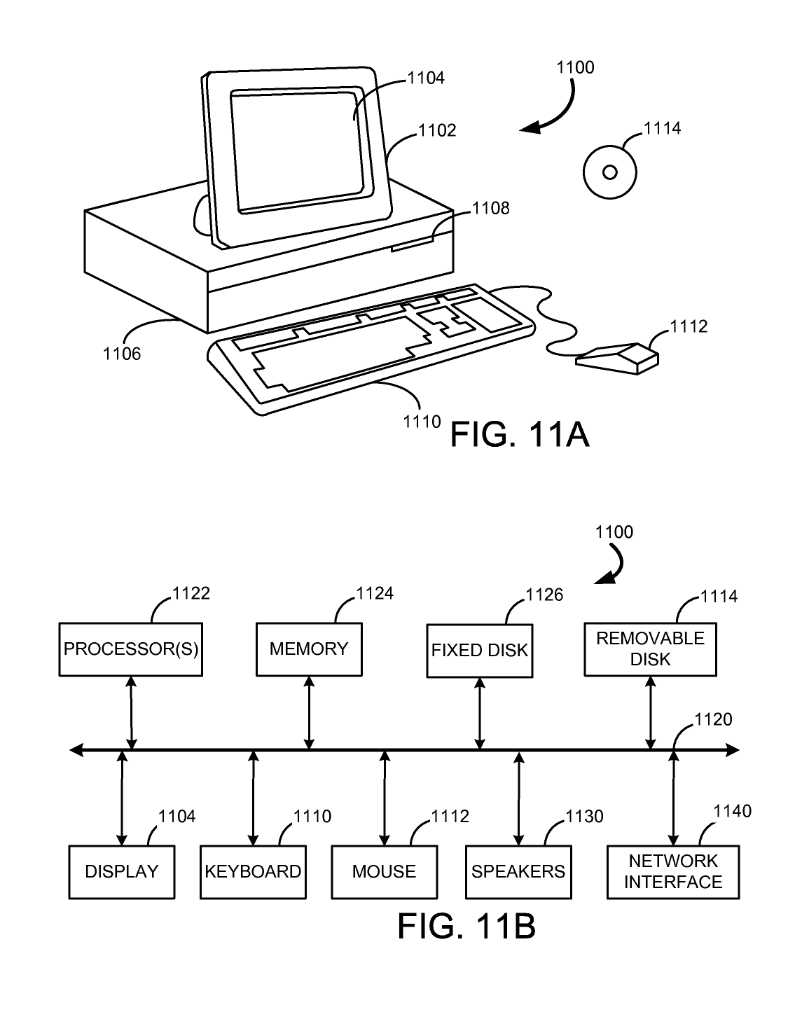

FIGS. 11A and 11B illustrate a Computer System 1100, which is suitable for implementing embodiments of the present invention. FIG. 11A shows one possible physical form of the Computer System 1100. Of course, the Computer System 1100 may have many physical forms ranging from a printed circuit board, an integrated circuit, and a small handheld device up to a huge super computer. Computer system 1100 may include a Monitor 1102, a Display 1104, a Housing 1106, a Disk Drive 1108, a Keyboard 1110, and a Mouse 1112. Disk 1114 is a computer-readable medium used to transfer data to and from Computer System 1100.

FIG. 11B is an example of a block diagram for Computer System 1100. Attached to System Bus 1120 are a wide variety of subsystems. Processor(s) 1122 (also referred to as central processing units, or CPUs) are coupled to storage devices, including Memory 1124. Memory 1124 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 1126 may also be coupled bi-directionally to the Processor 1122; it provides additional data storage capacity and may also include any of the computer-readable media described below. Fixed Disk 1126 may be used to store programs, data, and the like and is typically a secondary storage medium (such as a hard disk) that is slower than primary storage. It will be appreciated that the information retained within Fixed Disk 1126 may, in appropriate cases, be incorporated in standard fashion as virtual memory in Memory 1124. Removable Disk 1114 may take the form of any of the computer-readable media described below.

Processor 1122 is also coupled to a variety of input/output devices, such as Display 1104, Keyboard 1110, Mouse 1112 and Speakers 1130. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1122 optionally may be coupled to another computer or telecommunications network using Network Interface 1140. With such a Network Interface 1140, it is contemplated that the Processor 1122 might receive information from the network, or might output information to the network in the course of performing the above-described multi-merchant tokenization. Furthermore, method embodiments of the present invention may execute solely upon Processor 1122 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, the present invention provides systems and methods for interactive advertisements that link to distributed engagement channels. Such systems and methods reduce “banner blindness” in online advertising by displaying an interactive bridge field within the ad to users. The interactive bridge field may include live statistics pulled from a wide range of distribution channels. Upon user interaction, the systems and methods may display an expanded or mini DEC to the user for enhanced user experience.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for interactive advertisements, useful in association with a content management system, the method comprising:
generating an interactive bridge control for content;
optimizing the content for each at least one distribution channel and each at least one advertisement network;
publishing the optimized content on each at least one distribution channel and each at least one advertisement network, wherein the publishing on each of the at least one advertisement network includes the interactive bridge control;
monitoring for user interaction with the interactive bridge control, and when user interaction is detected displaying a distributed engagement channel; and
tracking user interaction with the interactive bridge control.

2. The method of claim 1, wherein the optimization comprises:
identifying a target result;
accessing a psychological profile that includes a persistent user identification, wherein the persistent user identification enables access to the psychological profile across a wide range of distribution channels; and
selecting content by increasing probabilities of the target result occurring based upon the psychological profile.

3. The method of claim 1, wherein the at least one distribution channel comprises any of social networks, blogs, media sources, news outlets, and retailers.

4. The method of claim 1, wherein the interactive bridge control includes live statistics.

5. The method of claim 4, wherein the live statistics are collected from the at least one distribution channel.

6. The method of claim 1, wherein the distributed engagement channel is one of a mini distributed engagement channel or an expanded distributed engagement channel.

7. The method of claim 6, wherein the mini distributed engagement channel includes content collected from each of the at least one distribution channel.

8. The method of claim 7, wherein the mini distributed engagement channel is displayed in line with the user's browsing.

9. The method of claim 6, wherein the expanded distributed engagement channel includes content collected from each of the at least one distribution channel, and is more content rich than the mini distributed engagement channel.

10. The method of claim 6, wherein the expanded distributed engagement channel is a branded website.

11. A content management system for providing interactive advertisements comprising:
an interactive bridge manager configured to generate an interactive bridge control for content;
a content optimizer configured to optimize the content for each at least one distribution channel and each at least one advertisement network;
a server configured to publish the optimized content on each at least one distribution channel and each at least one advertisement network, wherein the publishing on each of the at least one advertisement network includes the interactive bridge control;
the interactive bridge manager further configured to monitor for user interaction with the interactive bridge control, and when user interaction is detected displaying a distributed engagement channel; and
a tracker configured to track user interaction with the interactive bridge control.

12. The system of claim 11, wherein the content optimizer is configured to:
identify a target result;
access a psychological profile that includes a persistent user identification, wherein the persistent user identification enables access to the psychological profile across a wide range of distribution channels; and
select content by increasing probabilities of the target result occurring based upon the psychological profile.

13. The system of claim 11, wherein the at least one distribution channel comprises any of social networks, blogs, media sources, news outlets, and retailers.

14. The system of claim 11, wherein the interactive bridge control includes live statistics.

15. The system of claim 14, wherein the live statistics are collected from the at least one distribution channel.

16. The system of claim 11, wherein the distributed engagement channel is one of a mini distributed engagement channel or an expanded distributed engagement channel.

17. The system of claim 16, wherein the mini distributed engagement channel includes content collected from each of the at least one distribution channel.

18. The system of claim 17, wherein the mini distributed engagement channel is displayed in line with the user's browsing.

19. The system of claim 16, wherein the expanded distributed engagement channel includes content collected from each of the at least one distribution channel, and is more content rich than the mini distributed engagement channel.

20. The system of claim 16, wherein the expanded distributed engagement channel is a branded website.
